(19) United States
(12) Patent Application Publication
(10) Pub. No.: US 2026/0133792 A1
(43) Pub. Date: May 14, 2026

(54) ALGORITHMS FOR UPDATING SOFTWARE CODE IN FLASH MEMORY DURING SYSTEM OPERATION

(71) Applicant: Silicon Storage Technology, Inc., San Jose, CA (US)

(72) Inventors: Xian Liu, Sunnyvale, CA (US); SIMONE BARTOLI, Lecco (IT); STEFANO SIVERO, Comun Nuovo BG (IT); STEFANO SURICO, Bussero (Milan) (IT); GIUSEPPE MOIOLI, Alzano Lombardo (BG) (IT); LORENZO BEDARIDA, Vimercate (IT); JEAN FRANCOIS THIERY, Caromb Vaucluse (FR); SERGUEI JOURBA, Aix En Provence (FR); CATHERINE DECOBERT, Pourrieres (FR); NHAN DO, Saratoga, CA (US); JINHO KIM, Saratoga, CA (US); LATT TEE, San Francisco, CA (US)

(21) Appl. No.: 18/948,227

(22) Filed: Nov. 14, 2024

(51) Int. Cl. G06F 8/654; G06F 8/656

(52) U.S. Cl. CPC G06F 8/654; G06F 8/656

(57) ABSTRACT

In one example, a method comprises storing (n-1) partitions of a first image of code in a first set of banks in single-level cell format, wherein the first set of banks comprise (n-1) of n banks of flash memory cells; and storing (n-1) partitions of the first image and (n-1) partitions of a second image of code in a second set of banks in multi-level cell format, wherein the second set of banks comprise (n-1) of the n banks and the second set of banks comprises a bank not contained in the first set of banks.

### FIELD OF THE INVENTION

Numerous examples are disclosed of algorithms for updating software in flash memory in a system while the system is operating.

### BACKGROUND OF THE INVENTION

Complex software-based systems, such as automotive systems, utilize a substantial amount of software code stored in non-volatile storage. An example of such a system is shown in FIG. 1. System 100 comprises processing unit 101, memory 102, non-volatile storage 103, and network interface 104. Processing unit 101 comprises one or more microprocessors each comprising one or more processing cores. Memory 102 comprises DRAM, SRAM, or another type of volatile memory. Non-volatile storage 303 comprises an embedded NOR flash memory, a stand-alone NOR or NAND flash memory, a solid state drive, or another type of storage. A solid state drive can comprise one or more arrays of flash memory cells arranged in rows and columns. Network interface 104 comprises one or more of a wired transceiver (such as a network interface compliant with a wired protocol such as that known by the trademark ETHERNET) and a wireless transceiver (such as an interface compliant with a wireless protocol such as those known by the trademarks BLUETOOTH, RFID, NFC, WIFI, 3G, 4G, 5G, and LTE).

Non-volatile storage 103 stores code 105, which is software code that can be loaded into memory 102 and executed by processing unit 101. Code 105 can be updated over network interface 104, such as through an “over-the-air” (OTA) update in the situation where network interface 104 comprises a wireless transceiver. Code 105 might be updated while system 100 is in operation and code 105 is being executed by processing unit 101. In the situation where system 100 is an automotive vehicle, code 105 might be updated while the vehicle is in motion.

The ability to update code 105 while code 105 is being executed often is premised on creating multiple images of code 105, such as a primary image of code 105 and a secondary or backup image of code 105. This can be referred to as dual-image storage. When a first image of code 105 is being updated, code execution can be conducted from the second image of code 105.

Similarly, when the second image of code 105 is being updated, code execution can be conducted from the first image of code 105. After the update is completed, one of the images can be discarded or written over.

FIGS. 2-5 depicts examples of flash memory cells that can be used in non-volatile storage 103. U.S. Pat. No. 5,029,130 (“the 130 patent”), which is incorporated herein by reference, discloses an array of split gate non-volatile memory cells, which are a type of flash memory cells. Such a memory cell 210 is shown in FIG. 2. Each memory cell 210 includes source region 14 and drain region 16 formed in semiconductor substrate 12, with channel region 18 there between. Floating gate 20 is formed over and insulated from (and controls the conductivity of) a first portion of the channel region 18, and over a portion of the source region 14. Word line terminal 22 (which is typically coupled to a word line) has a first portion that is disposed over and insulated from (and controls the conductivity of) a second portion of the channel region 18, and a second portion that extends up and over the floating gate 20. The floating gate 20 and word line terminal 22 are insulated from the substrate 12 by a gate oxide. Bitline 24 is coupled to drain region 16.

Memory cell 210 is erased (where electrons are removed from the floating gate) by placing a high positive voltage on the word line terminal 22, which causes electrons on the floating gate 20 to tunnel through the intermediate insulation from the floating gate 20 to the word line terminal 22 via Fowler-Nordheim (FN) tunneling.

Memory cell 210 is programmed by source side injection (SSI) with hot electrons (where electrons are placed on the floating gate) by placing a positive voltage on the word line terminal 22, and a positive voltage on the source region 14. Electron current will flow from the drain region 16 towards the source region 14. The electrons will accelerate and become heated when they reach the gap between the word line terminal 22 and the floating gate 20. Some of the heated electrons will be injected through the gate oxide onto the floating gate 20 due to the attractive electrostatic force from the floating gate 20.

Memory cell 210 is read by placing positive read voltages on the drain region 16 and word line terminal 22 (which turns on the portion of the channel region 18 under the word line terminal). If the floating gate 20 is positively charged (i.e., erased of electrons), then the portion of the channel region 18 under the floating gate 20 is turned on as well, and current will flow across the channel region 18, which is sensed as the erased or “1” state. If the floating gate 20 is negatively charged (i.e., programmed with electrons), then the portion of the channel region under the floating gate 20 is mostly or entirely turned off, and current will not flow (or there will be little flow) across the channel region 18, which is sensed as the programmed or “0” state.

Table No. 1 depicts typical voltage and current ranges that can be applied to the terminals of memory cell 210 for performing read, erase, and program operations:

TABLE NO 1
Operation of Flash Memory Cell 210 of FIG. 2

| | | |
|---|---|---|
| WL | BL | SL |

| | | | | | | |
|---|---|---|---|---|---|---|
| Read | 2-3 | V | 0.6-2 | V | 0 | V |
| Erase | ~11-13 | V | 0 | V | 0 | V |
| Program | 1-2 | V | 1-5 | μA | 9-10 | V |

Other split gate memory cell configurations, which are other types of flash memory cells, are known. For example, FIG. 3 depicts a four-gate memory cell 310 comprising source region 14, drain region 16, floating gate 20 over a first portion of channel region 18, a select gate 22 (typically coupled to a word line, WL) over a second portion of the channel region 18, a control gate 28 over the floating gate 20, and an erase gate 30 over the source region 14. This configuration is described in U.S. Pat. No. 6,747,310, which is incorporated herein by reference for all purposes. Here, all gates are non-floating gates except floating gate 20, meaning that they are electrically connected or connectable to a voltage source. Programming is performed by heated electrons from the channel region 18 injecting themselves onto the floating gate 20. Erasing is performed by electrons tunneling from the floating gate 20 to the erase gate 30.

Table No. 2 depicts typical voltage and current ranges that can be applied to the terminals of memory cell 310 for performing read, erase, and program operations:

TABLE NO 2
Operation of Flash Memory Cell 310 of FIG. 3

| | WL/SG | | BL | | CG | | EG | | SL | |
|---|---|---|---|---|---|---|---|---|---|---|
| Read | 0.7-3 | V | 0.5-2 | V | 0-3 | V | 0-3 | V | 0 | V |
| Erase | 0 | V | 0 | V | 0 V/−8 V | | 8-13 | V | 0 | V |
| Program | 0.6-1.2 | V | 0.1-2 | μA | 8-12 | V | 4-9 | V | 4-5 | V |

FIG. 4 depicts a three-gate memory cell 410, which is another type of flash memory cell. Memory cell 410 is identical to the memory cell 310 of FIG. 3 except that memory cell 410 does not have a separate control gate. The erase operation (whereby erasing occurs through use of the erase gate) and read operation are similar to that of the FIG. 3 except there is no control gate bias applied. The programming operation also is done without the control gate bias, and as a result, a higher voltage is applied on the source line during a program operation to compensate for a lack of control gate bias.

Table No. 3 depicts typical voltage and current ranges that can be applied to the terminals of memory cell 410 for performing read, erase, and program operations:

TABLE NO 3
Operation of Flash Memory Cell 410 of FIG. 4

| | WL/SG | | BL | | EG | | SL | |
|---|---|---|---|---|---|---|---|---|
| Read | 0.7-3 | V | 0.5-2 | V | 0-3 | V | 0 | V |
| Erase | 0 | V | 0 | V | 11-13 | V | 0 | V |
| Program | 0.6-1.2 | V | 0.2-5 | μA | 3-6 | V | 6-10 | V |

FIG. 5 depicts stacked gate memory cell 510, which is another type of flash memory cell. Memory cell 510 is similar to memory cell 210 of FIG. 2, except that floating gate 20 extends over the entire channel region 18, and control gate 22 (which here will be coupled to a word line) extends over floating gate 20, separated by an insulating layer (not shown). The erase is done by FN tunneling of electrons from FG to substrate, programming is by channel hot electron (CHE) injection at region between the channel 18 and the drain region 16, by the electrons flowing from the source region 14 towards to drain region 16 and read operation which is similar to that for memory cell 210 with a higher control gate voltage.

Table No. 4 depicts typical voltage ranges that can be applied to the terminals of memory cell 510 and substrate 12 for performing read, erase, and program operations:

TABLE NO 4
Operation of Flash Memory Cell 510 of FIG. 5

| | CG | | BL | | SL | Substrate |
|---|---|---|---|---|---|---|
| Read | 2-5 | V | 0.5-2 | V | 0 V | 0 V |
| Erase | −8 to −10 V/0 V | | float | | float | 8-10 V/15-20 V |
| Program | 8-12 | V | 3-7 | V | 0 V | 0 V |

Flash memory cells such as cells 210, 310, 410, and 510 in FIGS. 2, 3, 4, and 5, respectively, are capable of storing one bit of data in a “single-level cell” (SLC) configuration or storing more than one bit of data in “multi-level cell” (MLC) configuration. In one approach, the stored bits are determined by applying certain voltages to terminals of the cell and reading the resulting current, referred to as a read current, and comparing the read current against one or more reference currents using a sense amplifier. A sense amplifier for an SLC cell might use a single reference current, where a read current greater than the reference current indicates a bit value of a first value (e.g., a “1”) and a read current less than the reference current indicates a bit value of a second value (e.g., a “0”). A sense amplifier for an MLC cell might use multiple reference currents. For example, an MLC with four possible levels might use three reference currents of different values, where the bit values are determined based on the relative size of the read current against each of the three reference currents. For example, if the reference currents are Ia, Ib, and Ic where Ta<Ib<Ic, a read current less than Ta might indicate bit values of a first value (e.g., “00”), a read current between Ta and Ib might indicate bit values of a second value (e.g., “01”), a read current between Ib and Ic might indicate bit values of a third value (e.g., “10”), and a read current greater than Ic might indicate bit values of a fourth value (e.g., “11”). It is to be understood that an MLC cell is not limited to this example of 4 levels and can have 8 levels, 16 levels, 32 levels, or more.

An MLC cell can store more data than an SLC cell for the same die space but an MLC cell takes longer than an SLC cell to program and verify. An MLC cell also has a smaller read window than an SLC cell, which makes an MLC cell more sensitive than an SLC cell to charge state drift over its data retention lifetime. Charge state drift results in an error if not corrected.

The methods and means described herein may apply to other non-volatile memory technologies that are capable of operating in SLC and MLC modes, such as FINFET split gate flash or stack gate flash memory, NAND flash, SONOS (silicon-oxide-nitride-oxide-silicon, charge trap in nitride), MONOS (metal-oxide-nitride-oxide-silicon, metal charge trap in nitride), ReRAM (resistive ram), PCM (phase change memory), MRAM (magnetic ram), FeRAM (ferroelectric ram), CT (charge trap) memory, CN (carbon-tube) memory, OTP (bi-level or multi-level one time programmable), and CeRAM (correlated electron ram), without limitation.

What is needed are improved algorithms for storing and updating software code in a non-volatile storage device in a system while the system is operating in a way that utilizes the benefits of SLC cells and MLC cells.

### SUMMARY OF THE INVENTION

Numerous examples are disclosed of algorithms for updating software in flash memory in a system while the system is operating.

In one example, a method comprises storing (n-1) partitions of a first image of code in a first set of banks in single-level cell format, wherein the first set of banks comprise (n-1) of n banks of flash memory cells; and storing (n-1) partitions of the first image and (n-1) partitions of a second image of code in a second set of banks in multi-level cell format, wherein the second set of banks comprise (n-1) of the n banks and the second set of banks comprises a bank not contained in the first set of banks.

In another example, a method comprises storing (n-1) partitions of a first image of code in a first set of banks in multi-level cell format, wherein the first set of banks comprises (n-1) of n banks of flash memory cells; and storing (n-1) partitions of the first image and (n-1) partitions of a second image of code in a second set of banks in multi-level cell format, wherein the second set of banks comprise (n-1) of the n banks and the second set of banks comprises a bank not contained in the first set of banks.

In another example, a method comprises storing (n-1) partitions of a first image of code and (n-1) partitions of a second image of code in a first set of banks in multi-level cell format, wherein the first set of banks comprises (n-1) of n banks of flash memory cells; and storing the (n-1) partitions of the second image of code in a second set of banks in single-level cell format, wherein the second set of banks comprise (n-1) of the n banks and the second set of banks comprises a bank not contained in the first set of banks.

In another example, a method comprises storing (n/2) partitions of a first image of code in a first set of banks selected from n banks of non-volatile memory cells in multi-level cell format, wherein the first set of banks comprise (n/2) of the n banks; and storing (n/2) partitions of a second image of code in a second set of banks in multi-level cell format, wherein the second set of banks comprise (n/2) of the n banks and the banks in the second set of banks are not contained in the first set of banks.

In another example, a method comprises storing a first image of code in a first bank of flash memory cells in multi-level cell format; and storing a second image of code in a second bank of flash memory cells in multi-level cell format.

In another example, a system comprises a processing unit; n banks of flash memory cells; and software code executable by the processing unit to receive an image of code and to store the image of code in n-1 banks of the n banks in multi-level cell format.

In another example, a method comprises in a system comprising n banks of flash memory cells and an old image of code stored across a first set of (n-1) banks of the n banks, storing a new image of code across a second set of (n-1) banks of the n banks, wherein the second set of (n-1) banks contains a bank not contained in the first set of (n-1) banks.

### BRIEF DESCRIPTION OF THE DRAWINGS

FIG. 1 depicts a system comprising code stored in non-volatile storage.

FIG. 2 depicts a split-gate flash memory cell.

FIG. 3 depicts a split-gate flash memory cell.

FIG. 4 depicts a split-gate flash memory cell.

FIG. 5 depicts a stacked-gate flash memory cell.

FIG. 6 depicts non-volatile storage comprising a plurality of banks.

FIG. 7 depicts an image of code divided into partitions.

FIGS. 8A and 8B depict an example of an algorithm for storing images of code in non-volatile storage.

FIGS. 9A and 9B depict an example of an algorithm for storing images of code in non-volatile storage.

FIG. 10 depicts an example of an algorithm for storing images of code in non-volatile storage.

FIG. 11 depicts an example of an algorithm for storing images of code in non-volatile storage.

### DETAILED DESCRIPTION OF THE INVENTION

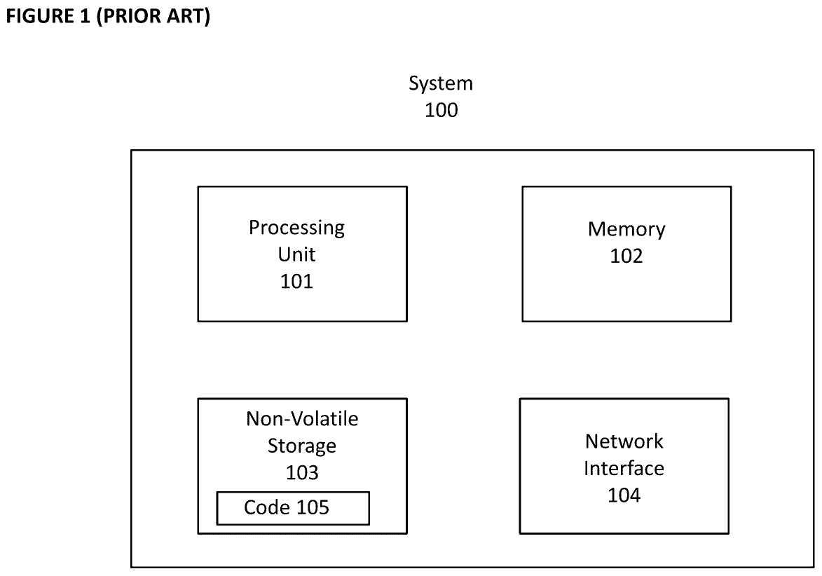

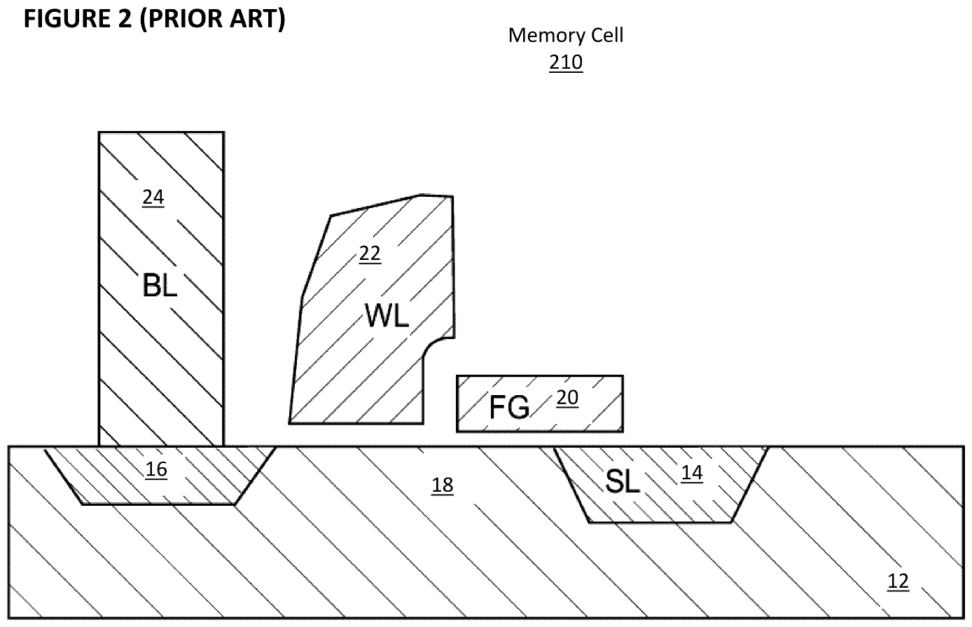

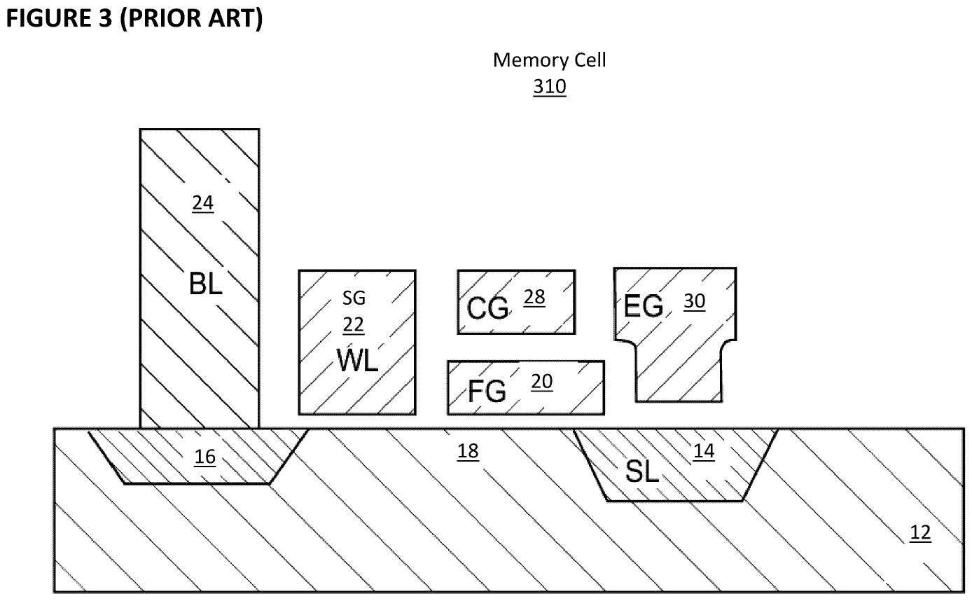

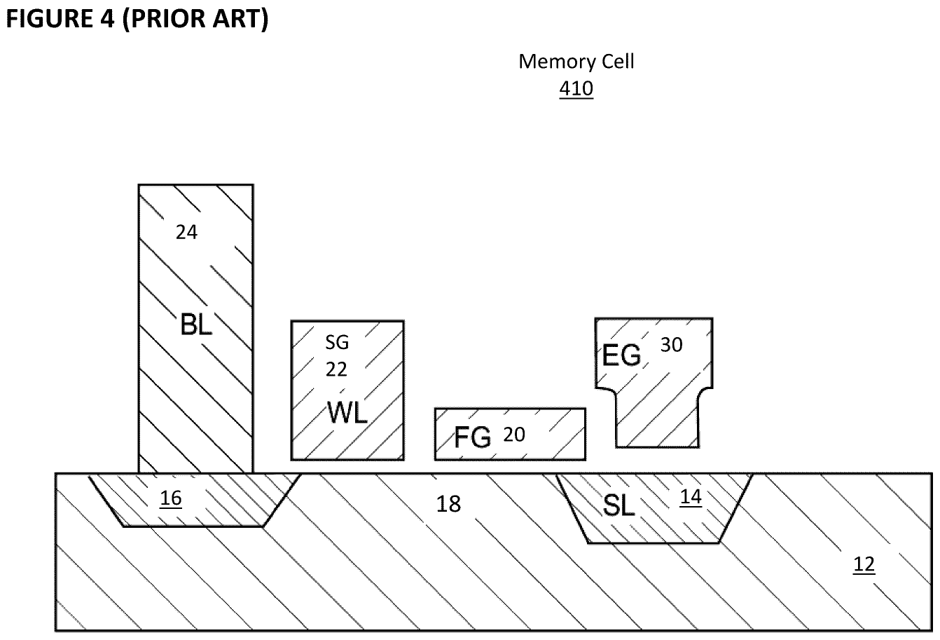

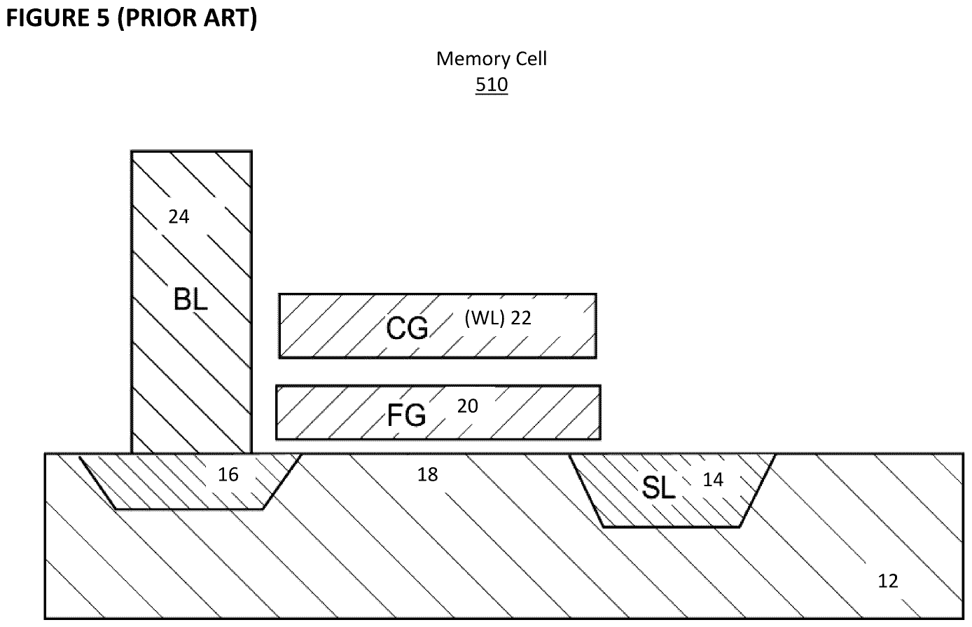

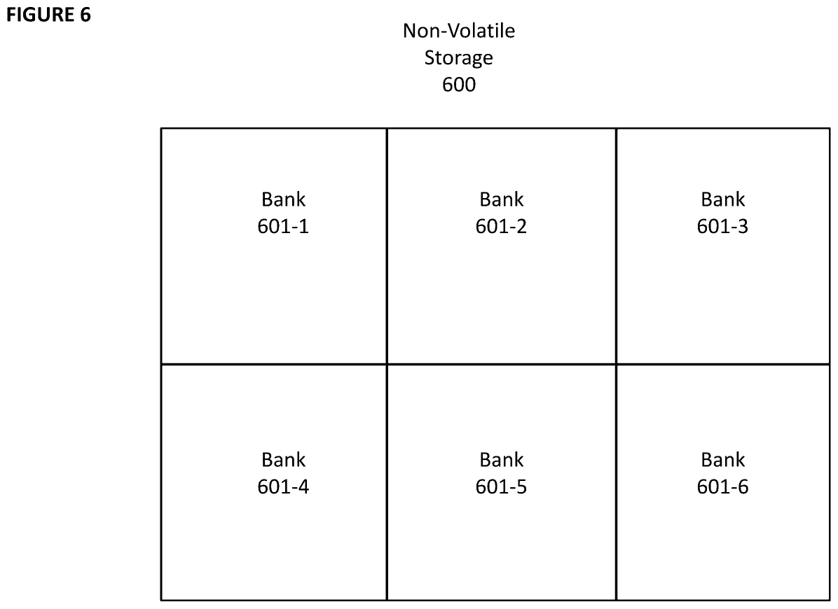

FIG. 6 depicts non-volatile storage 600, which is an example of non-volatile storage 103 in system 100 of FIG. 1. Non-volatile storage 600 comprises a plurality of banks, specifically, banks 601-1, 601-2, 601-3, 601-4, 601-5, and 601-6. It is to be understood that non-volatile storage 600 can comprise a greater or lesser number of banks. Each bank comprises one or more physical arrays of non-volatile memory cells arranged in rows and columns. The non-volatile memory cells can be flash memory cells of the type shown in FIGS. 2-5 as cells 210, 310, 410, and 510, respectively, or another type of cell.

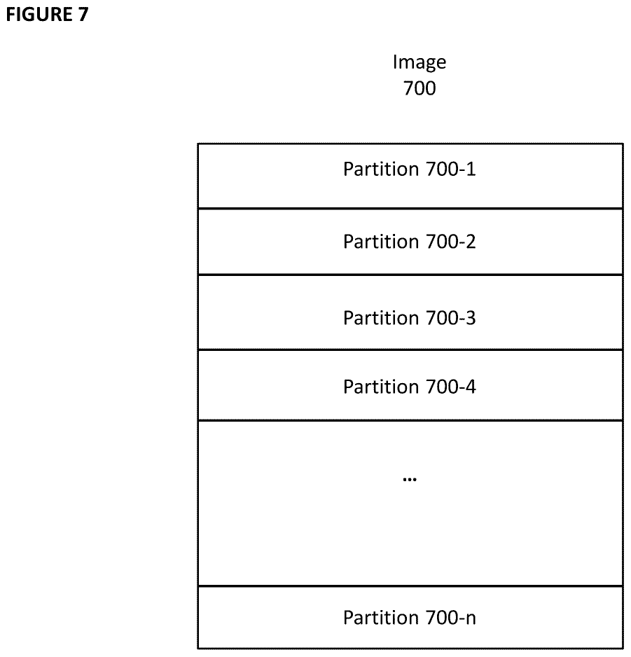

FIG. 7 depicts image 700, which is an example of code 105 in system 100 of FIG. 1. Image 700 can comprise, for example, an executable version of a software application executed by processing unit 101 of system 100. In this example, image 700 is stored in n different partitions, here, partitions 700-1, 700-2, 700-3, 700-4, . . . , 700-n. It is to be understood that image 700 might instead be stored in a greater or lesser number of partitions depending on its overall size and other considerations.

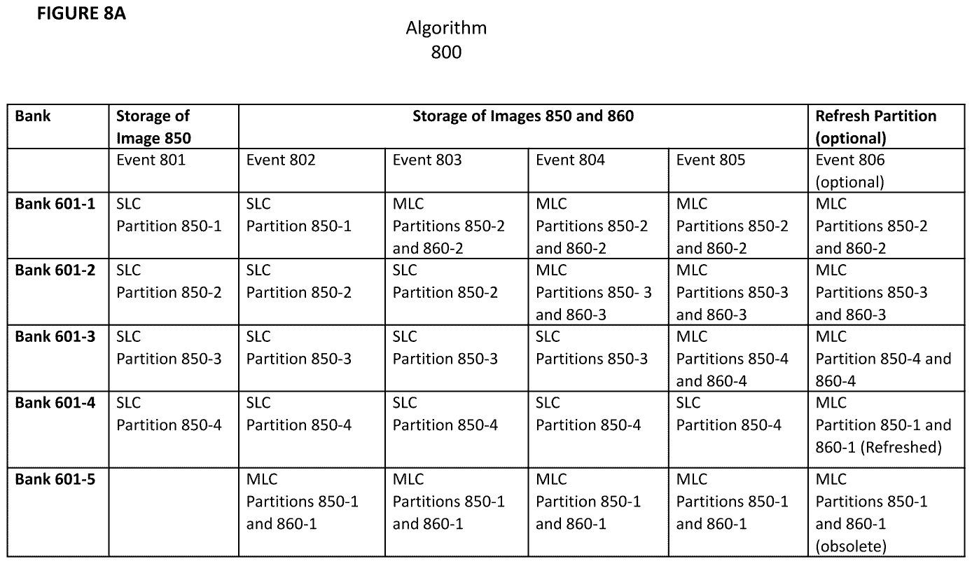

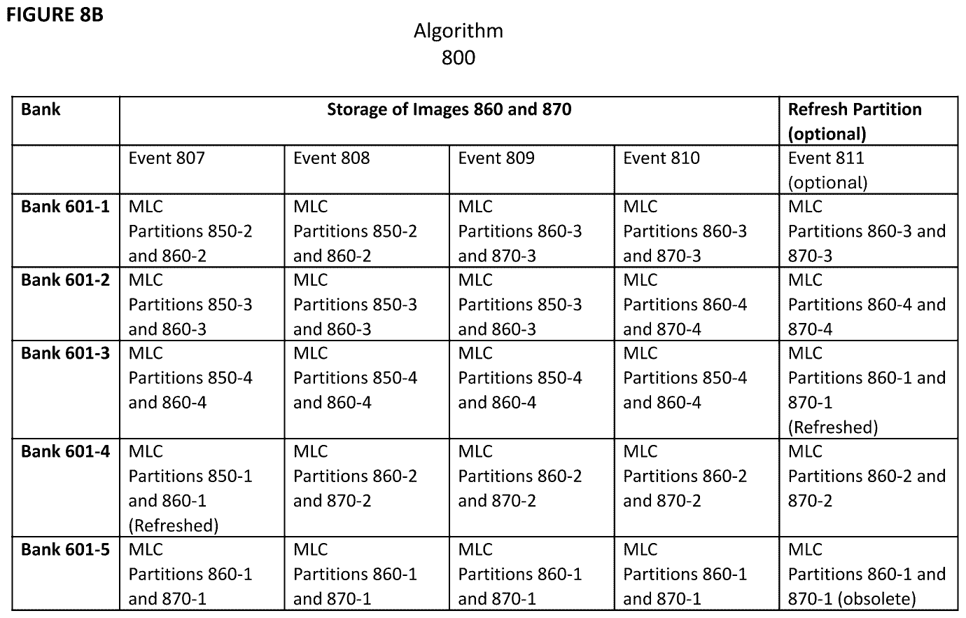

FIGS. 8A, 8B, 9A, 9B, 10, and 11 describe algorithms that can be implemented in code stored in non-volatile storage 103, loaded into memory 102, and implemented by processing unit 101 in system 100 in FIG. 1. These algorithms are utilized to store and update other code (such as code 105) in non-volatile storage 103. These algorithms comprise methods performed by system 100.

FIGS. 8A and 8B depict algorithm 800, which comprises an example sequence of events to store images 850, 860 and 870 in system 100, which are examples of image 700 in FIG. 7, in non-volatile storage 600 of FIG. 6. Algorithm 800 stores images 850, 860, and 870 in banks 601-1, 601-2, 601-3, 601-4, and 601-5.

Event 801 is the initial loading of code during the manufacturing process. Image 850 is stored as partitions 850-1, 850-2, 850-3, and 850-4 in banks 601-1, 601-2, 601-3, and 601-4, respectively, using SLC storage. The benefit of using SLC instead of MLC during manufacturing is that the programming process is faster for SLC than MLC and using SLC for event 801 will decrease manufacturing time.

Event 802 is the beginning of a code update, such as an OTA update, that occurs when system 100 is in the field. Specifically, image 860 is to be stored, beginning with partition 860-1 during event 802. It is desired to maintain a copy of image 850 while image 860 is being stored.

Partitions 850-1 and 860-1 are stored in bank 601-5 using MLC storage. Because banks 601-1, 601-2, 601-3, and 601-4 already contain the entirety of image 850, system 100 can store 850-1 and 860-1 using MLC storage because there is no time-pressure to complete the operation since image 850 is available for the system to use. The greater density of MLC enables bank 605-1 to store both partitions 850-1 and 860-1 even in the situation where either of those portions would fill nearly the entirety of bank 605-1 when SLC storage is used.

In event 803, another portion of image 860 is stored. Partitions 850-2 and 860-2 are stored in bank 601-1 using MLC storage.

In event 804, another portion of image 860 is stored. Partitions 850-3 and 860-3 are stored in bank 601-2 using MLC storage.

In event 805, another portion of image 860 is stored. Partitions 850-4 and 860-4 are stored in bank 601-3 using MLC storage. At the conclusion of event 805, banks 601-1, 601-2, 601-3, and 601-5 collectively contain the entirety of images 850 and 860.

Periodically, system 100 performs safety read operations to detect possible charge state drift within banks 601-1, 601-2, 601-3, and 601-5 where one or more cells are no longer storing the intended charge state, and determine if a data refresh is needed to correct the drift and prevent system malfunction. This safety read can be performed using a more stringent read condition that that used in code execution (user read), or using an error correction code (ECC) engine during a user read operation. After a certain amount of chart state drift errors have been detected, system 100 can perform a refresh operation whereby data is copied from a first bank, error correction is performed, and the corrected data is stored in a second bank, which will enable code to continue to be executed from the first bank while the refresh operation is performed. In optional event 806, a refresh operation is performed. In this example, a charge state drift error has been detected in partitions 850-1 or 860-1. It is to be understood that the charge state drift error can occur and be detected in any partition and that partitions 850-1 and 860-1 here are used as an example. The system copies the data for partitions 850-1 and 860-1 from bank 601-5, performs error correction on the data, and stores the refreshed data for partitions 850-1 and 860-1 in bank 601-4.

Event 807 is the beginning of another code update, such as an OTA update, that occurs when the system is in the field. Specifically, image 870 is to be stored, beginning with partition 870-1 during event 807. Image 850 is obsolete because image 860 is now being executed and image 850 will be overwritten beginning with event 807. It is desired to maintain a copy of image 860 while image 870 is being stored. Partitions 860-1 and 870-1 are stored in bank 601-5 using MLC storage. Because banks 601-1, 601-2, 601-3, and 601-4 already contain the entirety of image 860, system 100 can store 860-1 and 870-1 using MLC storage because there is no time-pressure to complete the operation since image 860 is available for the system to use. The greater density of MLC enables bank 601-5 to store both partitions 860-1 and 870-1 even in the situation where either of those portions would fill nearly the entirety of bank 605-1 when SLC storage is used.

In event 808, another portion of image 870 is stored. Partitions 860-2 and 870-2 are stored in bank 601-4 using MLC storage.

In event 809, another portion of image 870 is stored. Partitions 860-3 and 870-3 are stored in bank 601-1 using MLC storage.

In event 810, another portion of image 870 is stored. Partitions 860-4 and 870-4 are stored in bank 601-2 using MLC storage.

In optional event 811, another refresh operation is performed after a charge state drift error is detected in partitions 860-1 or 870-1. It is to be understood that the charge state drift error can occur and be detected in any partition and that partitions 860-1 and 870-1 here are used as an example. The system copies the data for partitions 860-1 and 870-1 from bank 601-5, performs error correction on the data, and stores the refreshed data for partitions 860-1 and 870-1 in bank 601-3.

More generally, one portion of algorithm 800 can be characterized as storing (n-1) partitions of a first image of code in a first set of banks in single-level cell format, wherein the first set of banks comprise (n-1) of n banks of flash memory cells; and storing (n-1) partitions of the first image and (n-1) partitions of a second image of code in a second set of banks in multi-level cell format, wherein the second set of banks comprise (n-1) of the n banks and the second set of banks comprises a bank not contained in the first set of banks.

Another portion of algorithm 800 can be characterized as storing (n-1) partitions of a first image and (n-1) partitions of a second image of code in a first set of banks in multi-level cell format, wherein the first set of banks comprises (n-1) of n banks of flash memory cells; and storing (n-1) partitions of the second image and (n-1) partitions of a third image of code in a second set of banks in multi-level cell format, wherein the second set of banks comprise (n-1) of the n banks and the second set of banks comprises a bank not contained in the first set of banks.

Additional OTA updates and refresh operations can be performed throughout the lifetime of system 100 using the principles described above for algorithm 800.

Thus, algorithm 800 maintains two images beginning when the first code update is complete. It allows for data to be refreshed at any time, as there will always be either one image of factory code or two images of OTA code that can be used. Algorithm 800 performs wear leveling within the various banks. All banks experience on average 80% of an MLC erase and program cycle during each code update (as 4 of 5 banks are involved in each code update) and 20% of an MLC erase and program cycle per refresh operation (as 1 of 5 banks are involved in each code update).

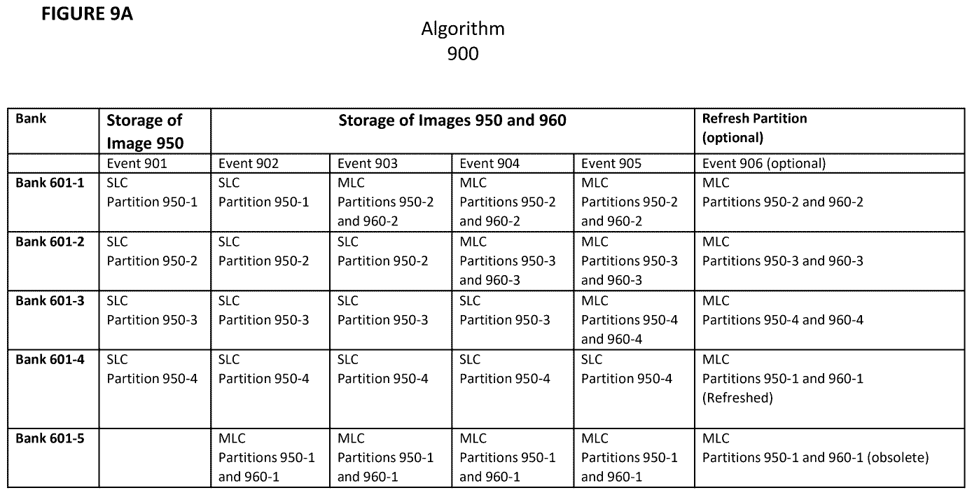

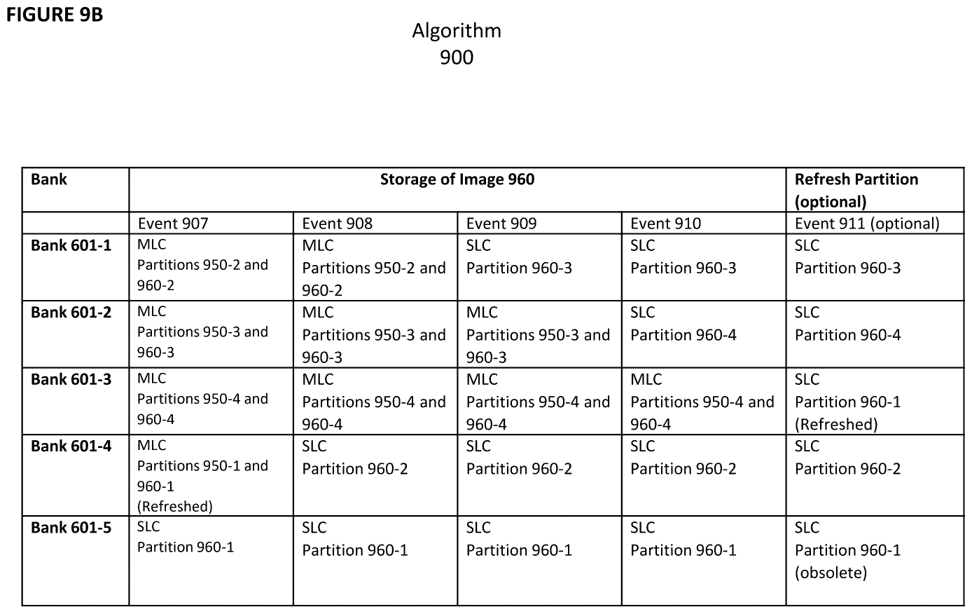

FIGS. 9A and 9B depict algorithm 900, which comprises an example sequence of events to store images 950 and 960, which are examples of image 700 in FIG. 7, in non-volatile storage 600 of FIG. 6. Algorithm 900 stores images 950 and 960 in banks 601-1, 601-2, 601-3, 601-4, and 601-5.

Event 901 is the initial loading of code during the manufacturing process. Image 950 is stored as partitions 950-1, 950-2, 950-3, and 950-4 in banks 601-1, 601-2, 601-3, and 601-4, respectively, using SLC storage. The benefit of using SLC instead of MLC during manufacturing is that the programming process is faster for SLC than MLC and using SLC for event 801 will decrease manufacturing time.

Event 902 is the beginning of a code update, such as an OTA update, that occurs when the system is in the field. Specifically, image 960 is to be stored, beginning with partition 960-1 during event 902. It is desired to maintain a copy of image 950 while image 960 is being stored.

Partitions 950-1 and 960-1 are stored in bank 601-5 using MLC storage. Because banks 601-1, 601-2, 601-3, and 601-4 already contain the entirety of image 950, system 100 can store 950-1 and 960-1 using MLC storage because there is no time-pressure to complete the operation since image 950 is available for the system to use. The greater density of MLC enables bank 605-1 to store both partitions 950-1 and 960-1 even in the situation where either of those portions would fill nearly the entirety of bank 605-1 when SLC storage is used.

In event 903, another portion of image 960 is stored. Partitions 950-2 and 960-2 are stored in bank 601-2 using MLC storage.

In event 904, another portion of image 960 is stored. Partitions 950-3 and 960-3 are stored in bank 601-2 using MLC storage.

In event 905, another portion of image 960 is stored. Partitions 950-4 and 960-4 are stored in bank 601-3 using MLC storage. At the conclusion of event 905, banks 601-1, 601-2, 601-3, and 601-5 collectively contain the entirety of images 950 and 960.

In optional event 906, a refresh operation is performed after a charge state drift error is detected in partitions 950-1 or 960-1. It is to be understood that the charge state drift error can occur and be detected in any partition and that partitions 950-1 and 960-1 here are used as an example. The system copies the data for partitions 950-1 and 960-1 from bank 601-5, performs error correction on the data, and stores the refreshed data for partitions 950-1 and 960-1 in bank 601-4.

Event 907 is the beginning of a conversion process whereby image 960 will be stored in SLC form instead of MLC form. This can be useful because data in SLC form is less susceptible to data drift errors. It is desired to maintain a copy of image 960 at all times so that it can still be executed. Partition 960-1 is stored in bank 601-5 using SLC storage.

In event 908, another portion of image 960 is stored in SLC form. Partition 960-2 is stored in bank 601-4 using SLC storage.

In event 909, another portion of image 960 is stored in SLC form. Partition 960-3 is stored in bank 601-1 using SLC storage.

In event 910, another portion of image 960 is stored in SLC form. Partition 960-4 is stored in bank 601-2 using SLC storage.

In optional event 911, another refresh operation is performed after a charge state drift error is detected in partition 960-1. It is to be understood that the charge state drift error can occur and be detected in any partition and that partition 960-1 here is used as an example. The system copies the data for partition 960-1 from bank 601-5, performs error correction on the data, and stores the refreshed data for partition 960-1 in bank 601-3.

More generally, one portion of algorithm 900 can be characterized as storing (n-1) partitions of a first image of code in a first set of banks in single-level cell format, wherein the first set of banks comprises (n-1) of n banks of flash memory cells; and storing (n-1) partitions of the first image and (n-1) partitions of a second image of code in a second set of banks in multi-level cell format, wherein the second set of banks comprise (n-1) of the n banks and the second set of banks comprises a bank not contained in the first set of banks. Algorithm 900 can further comprise storing the (n-1) partitions of the second image of code in a third set of banks in single-level cell format, wherein the third set of banks comprise (n-1) of the n banks and the third set of banks comprises a bank not contained in the second set of banks.

Another portion of algorithm 900 can be characterized as storing (n-1) partitions of a first image and (n-1) partitions of a second image of code in a first set of banks in multi-level cell format, wherein the first set of banks comprises (n-1) of n banks of flash memory cells; and storing the (n-1) partitions of the second image of code in a second set of banks in single-level cell format, wherein the second set of banks comprise (n-1) of the n banks and the second set of banks comprises a bank not contained in the first set of banks.

Additional OTA updates and refresh operations can be performed throughout the lifetime of system 100 using the principles described above for algorithm 900.

Thus, algorithm 900 maintains one image of factory code, two images during OTA code updates and for a flexible period afterward, during which new image can be validated, and one image of OTA code after its validation is complete. It allows for data to be refreshed at any time, as there will always be either one or two images that can be used. Long-term storage will use SLC, which has a higher reliability than MLC due to lesser susceptibility to charge state drift.

Algorithm 900 performs wear leveling. The banks will experience greater wear compared to algorithm 800. All banks experience on average 80% of an MLC erase and program cycle and 80% of an SLC erase and program cycle during each code update (as 4 of 5 banks are involved in each code update) and 20% of an MLC erase and program cycle or an SLC erase and program cycle per refresh operation (as 1 of 5 banks are involved in each code update).

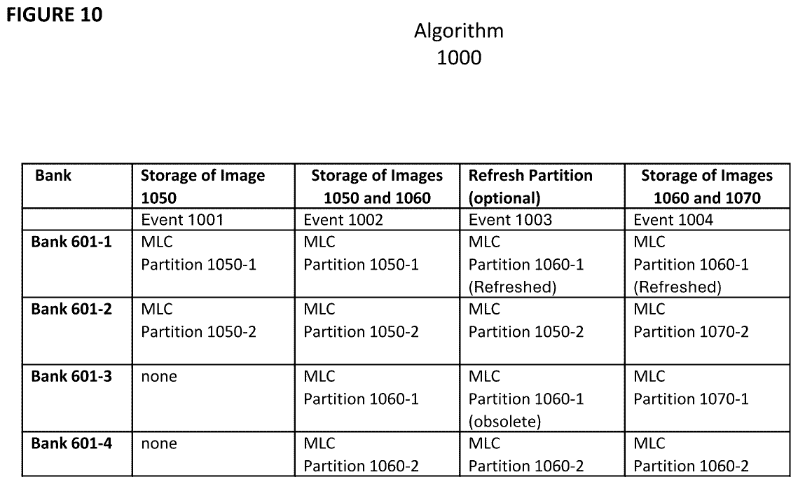

FIG. 10 depicts algorithm 1000, which comprises an example sequence of events to store images 1050 and 1060, which are examples of image 700 in FIG. 7, in non-volatile storage 600 of FIG. 6. Algorithm 1000 stores images 1050, 1060, and 1070 in banks 601-1, 601-2, 601-3, and 601-4. Thus, algorithm 1000 utilizes less die space (4 banks) than algorithms 800 and 900 of FIGS. 8A, 8B, 9A, and 9B (5 banks).

Event 1001 is the initial loading of code during the manufacturing process. Image 1050 is stored as partitions 1050-1 and 1050-2 in banks 601-1 and 601-2. respectively, using MLC storage, which will take more time for the programming process compared to a situation where SLC is used instead.

Event 1002 is a code update, such as an OTA update, that occurs when the system is in the field. Specifically, image 1060 is to be stored. It is desired to maintain a copy of image 1050 while image 1060 is being stored. Partition 1060-1 is stored in bank 601-3 using MLC storage, and partition 1060-2 is stored in bank 601-4 using MLC storage. Because banks 601-1 and 601-2 already contain the entirety of image 1050, system 100 can store 1060-1 and 1060-2 using MLC storage because there is no time-pressure to complete the operation since image 1050 is available for the system to use.

In optional event 1003, a refresh operation is performed after a data drift error is detected in partition 1060-1. It is to be understood that the data drift error can occur and be detected in any partition and that partition 1060-1 here is used as an example. The system copies the data for partition 1060-1 from bank 601-3, performs error correction on the data, and stores the refreshed data for partition 1060-1 in bank 601-1.

Event 1004 is another code update, such as an OTA update, that occurs when the system is in the field. Specifically, image 1070 is to be stored. It is desired to maintain a copy of image 1060 while image 1070 is being stored. Partition 1070-1 is stored in bank 601-3 using MLC storage, and partition 1070-2 is stored in bank 601-2 using MLC storage. Because banks 601-1 and 601-4 already contain the entirety of image 1060, system 100 can store 1070-1 and 1070-2 using MLC storage because there is no time-pressure to complete the operation since image 1070 is available for the system to use.

More generally, one portion of algorithm 1000 can be characterized as storing (n/2) partitions of a first image of code in a first set of banks in multi-level cell format, wherein the first set of banks comprise n/2) of the n banks; and storing (n/2) partitions of a second image of code in a second set of banks in multi-level cell format, wherein the second set of banks comprise (n/2) of the n banks and the banks in the second set of banks are not contained in the first set of banks.

Additional OTA updates and refresh operations can be performed throughout the lifetime of system 100 using the principles described above for algorithm 1000.

Thus, algorithm 1000 maintains two images beginning when the first code update is complete during the code update and validation periods. It allows for data to be refreshed outside of the code update and validation period. Algorithm 1000 performs wear leveling. The wear will be better than for algorithms 800 and 900. All banks experience on average 50% of an MLC erase and program cycle during each code update (as 2 of 4 banks are involved in each code update) and 25% of an MLC erase and program cycle per refresh operation (as 1 of 4 banks are involved in each refresh).

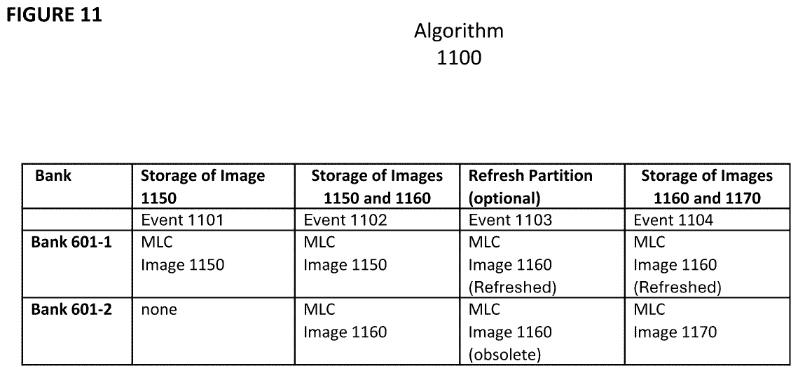

FIG. 11 depicts algorithm 1100, which comprises an example sequence of events to store images 1150, 1160, and 1170, which are examples of image 700 in FIG. 7, in non-volatile storage 600 of FIG. 6. Algorithm 1100 stores images 1150, 1160, and 1170 in banks 601-1, 601-2, 601-3, 601-4, and 601-5.

Event 1101 is the initial loading of code during the manufacturing process. Image 1150 is in its entirety in bank 601-1 using MLC storage, which will take more time for the programming process compared to a situation where SLC is used instead.

Event 1102 is a code update, such as an OTA update, that occurs when the system is in the field. Specifically, image 1160 is to be stored. It is desired to maintain a copy of image 1150 while image 1160 is being stored. Image 1160 is stored in its entirety in bank 601-2 using MLC storage. Because banks 601-1 already contains the entirety of image 1150, system 100 can store image 1160 using MLC storage because there is no time-pressure to complete the operation since image 1150 is available for the system to use.

In optional event 1103, a refresh operation is performed after a data drift error is detected in image 1160. The system copies the data for image 1160 from bank 601-2, performs error correction on the data, and stores the refreshed data for image in bank 601-1.

Event 1104 is another code update, such as an OTA update, that occurs when the system is in the field. Specifically, image 1170 is to be stored. It is desired to maintain a copy of image 1160 while image 1170 is being stored. Image 1170 is stored in its entirety in bank 601-2 using MLC storage. Because banks 601-1 already contains the entirety of image 1160, system 100 can store image 1170 using MLC storage because there is no time-pressure to complete the operation since image 1160 is available for the system to use.

More generally, one portion of algorithm 1100 can be characterized as storing a first image of code in a first bank of flash memory cells in multi-level cell format; and storing a second image of code in a second bank of flash memory cells in multi-level cell format.

Additional OTA updates and refresh operations can be performed throughout the lifetime of system 100 using the principles described above for algorithm 800.

Thus, algorithm 1100 maintains two images beginning when the first code update is complete during the code update and validation periods. It allows for data to be refreshed outside of the code update and validation period. Algorithm 1100 performs wear leveling. The wear will be better than for algorithms 800 and 900. All banks experience on average 50% of an MLC erase and program cycle during each code update (as 1 of 2 banks are involved in each code update) and 50% of an MLC erase and program cycle per refresh operation (as 1 of 2 banks are involved in each refresh).

As used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements there between.

1. A method comprising:
storing (n-1) partitions of a first image of code in a first set of banks in single-level cell format, wherein the first set of banks comprise (n-1) of n banks of flash memory cells; and
storing (n-1) partitions of the first image and (n-1) partitions of a second image of code in a second set of banks in multi-level cell format, wherein the second set of banks comprise (n-1) of the n banks and the second set of banks comprises a bank not contained in the first set of banks.

2. The method of claim 1, wherein n=4.

3. The method of claim 1, comprising:
performing a refresh operation on a bank in the first set of banks.

4. The method of claim 1, comprising:
performing a refresh operation on a bank in the second set of banks.

5. The method of claim 1, comprising:
storing (n-1) partitions of the second image and (n-1) partitions of a third image of code in a third set of banks in multi-level cell format, wherein the third set of banks comprise (n-1) of the n banks and the third set of banks comprises a bank not contained in the second set of banks.

6. The method of claim 5, comprising:
performing a refresh operation on a bank in the third set of banks.

7. The method of claim 1, comprising:
receiving the (n-1) partitions of the second image of code over a wireless network interface.

8. The method of claim 1, comprising:
storing the (n-1) partitions of the second image of code in a third set of banks in single-level cell format, wherein the third set of banks comprise (n-1) of the n banks and the third set of banks comprises a bank not contained in the second set of banks.

9. The method of claim 8, wherein n=4.

10. The method of claim 8, comprising:
performing a refresh operation on a bank in the second set of banks.

11. The method of claim 8, comprising:
performing a refresh operation on a bank in the second set of banks.

12. The method of claim 8, comprising:
receiving the (n-1) partitions of the second image of code over a wireless network interface.

13. A method comprising:
storing (n-1) partitions of a first image of code in a first set of banks in multi-level cell format, wherein the first set of banks comprises (n-1) of n banks of flash memory cells; and
storing (n-1) partitions of the first image and (n-1) partitions of a second image of code in a second set of banks in multi-level cell format, wherein the second set of banks comprise (n-1) of the n banks and the second set of banks comprises a bank not contained in the first set of banks.

14. The method of claim 13, wherein n=4.

15. The method of claim 13, comprising:
performing a refresh operation on a bank in the second set of banks.

16. The method of claim 13, comprising:
performing a refresh operation on a bank in the second set of banks.

17. The method of claim 13, comprising:
receiving the (n-1) partitions of the first image of code over a wireless network interface.

18. The method of claim 17, comprising:
receiving the (n-1) partitions of the second image of code over the wireless network interface.

19. A method comprising:
storing (n-1) partitions of a first image of code and (n-1) partitions of a second image of code in a first set of banks in multi-level cell format, wherein the first set of banks comprises (n-1) of n banks of flash memory cells; and
storing the (n-1) partitions of the second image of code in a second set of banks in single-level cell format, wherein the second set of banks comprise (n-1) of the n banks and the second set of banks comprises a bank not contained in the first set of banks.

20. The method of claim 19, wherein n=4.

21. The method of claim 19, comprising:
performing a refresh operation on a bank in the first set of banks.

22. The method of claim 19, comprising:
performing a refresh operation on a bank in the second set of banks.

23. The method of claim 19, comprising:
receiving the (n-1) partitions of the first image of code over a wireless network interface.

24. A method comprising:
storing (n/2) partitions of a first image of code in a first set of banks selected from n banks of non-volatile memory cells in multi-level cell format, wherein the first set of banks comprise (n/2) of the n banks; and
storing (n/2) partitions of a second image of code in a second set of banks in multi-level cell format, wherein the second set of banks comprise (n/2) of the n banks and the banks in the second set of banks are not contained in the first set of banks.

25. The method of claim 24, comprising:
performing a refresh operation on a bank in the first set of banks.

26. The method of claim 24, comprising:
performing a refresh operation on a bank in the second set of banks.

27. The method of claim 24, comprising:
receiving the (n/2) partitions of the second image of code over a wireless network interface.

28. The method of claim 24, comprising:
storing (n/2) partitions of a third image of code in a third set of banks in multi-level cell format, wherein the third set of banks comprise (n/2) of the n banks and the third set of banks contains a bank not contained in the second set of banks.

29. A method comprising:
storing a first image of code in a first bank of flash memory cells in multi-level cell format; and
storing a second image of code in a second bank of flash memory cells in multi-level cell format.

30. The method of claim 29, comprising:
performing a refresh operation on code stored in one of the first bank and the second bank to generate refreshed code and storing the refreshed code in the other of the first bank and the second bank.

31. The method of claim 29, comprising:
storing a third image of code in one of the first bank and the second bank in multi-level cell format.

32. The method of claim 31, comprising:
receiving the second image of code over a wireless network interface.

33. The method of claim 32, comprising:
receiving the third image of code over the wireless network interface.

34. A system comprising:
a processing unit;
n banks of flash memory cells; and
software code executable by the processing unit to receive an image of code and to store the image of code in n-1 banks of the n banks in multi-level cell format.

35. A method comprising:
in a system comprising n banks of flash memory cells and an old image of code stored across a first set of (n-1) banks of the n banks, storing a new image of code across a second set of (n-1) banks of the n banks, wherein the second set of (n-1) banks contains a bank not contained in the first set of (n-1) banks.
